(19) United States
(12) Patent Application Publication
(10) Pub. No.: US 2025/0063429 A1
(43) Pub. Date: Feb. 20, 2025

(54) SYSTEMS AND METHODS FOR MACHINE LEARNING BASED RADIO RESOURCE USAGE FOR IMPROVING COVERAGE AND CAPACITY

(71) Applicant: CommScope Technologies LLC, Claremont, NC (US)

(72) Inventor: Harsha Hegde, Hawthorn Woods, IL (US)

(73) Assignee: CommScope Technologies LLC, Claremont, NC (US)

(21) Appl. No.: 18/724,135

(22) PCT Filed: Jan. 12, 2023
(86) PCT No.: PCT/US2023/060576

§ 371 Date: Jun. 25, 2024

Related U.S. Application Data
(60) Provisional application No. 63/300,725, filed on Jan. 19, 2022.

(51) Int. Cl. H04W 28/086; H04W 28/08

(52) U.S. Cl. CPC H04W 28/0861; H04W 28/0942

(57) ABSTRACT

Systems and methods for machine learning based radio resource usage are provided. In one example, a system includes BBU(s), RU(s) communicatively coupled to the BBU(s), and antenna(s) communicatively coupled to the RU(s). Each respective RU is communicatively coupled to a respective subset of the antenna(s). The BBU(s), the RU(s), and the antenna(s) are configured to implement a base station for wirelessly communicating with user equipment. The system further includes a machine learning computing system. The machine learning computer system is configured to receive time data and traffic data and determine a predicted radio resource usage of the base station based on the time data and the traffic data. The system is configured to adjust operation of at least one RU based on the predicted radio resource usage of the base station.

### CROSS-REFERENCE TO RELATED APPLICATIONS

This application claims the benefit of U.S. Provisional Application No. 63/300,725, filed on Jan. 19, 2022, entitled “SYSTEMS AND METHODS FOR MACHINE LEARNING BASED RADIO RESOURCE USAGE FOR IMPROVING COVERAGE AND CAPACITY,” the contents of which are incorporated herein by reference.

### BACKGROUND

A centralized or cloud radio access network (C-RAN) is one way to implement base station functionality. Typically, for each cell (that is, for each physical cell identifier (PCI)) implemented by a C-RAN, one or more baseband unit (BBU) entities (also referred to here simply as “BBUs”) interact with multiple remote units (also referred to here as “RUs,” “radio units,” “radio points,” or “RPs”) to implement a base station entity in order to provide wireless service to various items of user equipment (UEs). The BBU entities may comprise a single entity (sometimes referred to as a “baseband controller” or simply a “baseband band unit” or “BBU”) that performs Layer-3, Layer-2, and some Layer-1 processing for the cell. The BBU entities may also comprises multiple entities, for example, one or more central unit (CU) entities that implement Layer-3 and non-time critical Layer-2 functions for the associated base station and one or more distribution units (DU) that implement the time critical Layer-2 functions and at least some of the Layer-1 (also referred to as the Physical Layer) functions for the associated base station. Each CU can be further partitioned into one or more user-plane and control-plane entities that handle the user-plane and control-plane processing of the CU, respectively. Each such user-plane CU entity is also referred to as a “CU-UP,” and each such control-plane CU entity is also referred to as a “CU-CP.” In this example, each RU is configured to implement the radio frequency (RF) interface and the physical layer functions for the associated base station that are not implemented in the DU. The multiple RUs are typically located remotely from each other (that is, the multiple RUs are not co-located), and the BBU entities are communicatively coupled to the remote units over a fronthaul network. The RUs may also be collocated (for example, in instances where each RU processes different carriers or time slices).

### SUMMARY

In one aspect, a system includes at least one baseband unit (BBU), one or more radio units communicatively coupled to the at least one BBU, and one or more antennas communicatively coupled to the one or more radio units. Each respective radio unit of the one or more radio units is communicatively coupled to a respective subset of the one or more antennas. The at least one BBU, the one or more radio units, and the one or more antennas are configured to implement a base station for wirelessly communicating with user equipment. The system further includes a machine learning computing system. The machine learning computer system is configured to receive time data and traffic data and determine a predicted radio resource usage of the base station based on the time data and the traffic data. The system is configured to adjust operation of at least one radio unit of the one or more radio units based on the predicted radio resource usage of the base station.

In another aspect, a method includes receiving time data and traffic data. The method further includes determining a predicted radio resource usage of a base station based on the time data and the traffic data. The base station includes at least one baseband unit (BBU), one or more radio units communicatively coupled to the at least one BBU, and one or more antennas communicatively coupled to the one or more radio units. Each respective radio unit of the one or more radio units is communicatively coupled to a respective subset of the one or more antennas. The at least one BBU, the one or more radio units, and the one or more antennas are configured to implement a base station for wirelessly communicating with user equipment. The method further includes adjusting operation of at least one radio unit of the one or more radio units based on the predicted radio resource usage of the base station.

### BRIEF DESCRIPTION OF THE DRAWINGS

Understanding that the drawings depict only exemplary embodiments and are not therefore to be considered limiting in scope, the exemplary embodiments will be described with additional specificity and detail through the use of the accompanying drawings, in which:

FIGS. 1A-1B are block diagrams illustrating example radio access networks;

FIG. 2 is a diagram of example variables for machine learning model;

FIG. 3 is a block diagram illustrating an example radio access network; and

FIG. 4 is a flow diagram illustrating an example method of radio resource usage.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be used and that logical, mechanical, and electrical changes may be made. Furthermore, the method presented in the drawing figures and the specification is not to be construed as limiting the order in which the individual acts may be performed. The following detailed description is, therefore, not to be taken in a limiting sense.

In fifth generation (5G) New Radio (NR) campus and venue networks, radio units (RUs) are placed at different points based on the expected coverage and capacity needs during the initial deployment of the network. The specific locations for the RUs are determined based on the expected number of users and the associated traffic at different points within the campus or venue. However, the locations of the RUs are not determined based on a real-time number of users or the real-time traffic at those different points, and all RUs are typically powered on and considered for frequency reuse during operation. The initial deployment of the network will also generally need to be adjusted to address the changes in demand over time, which adds cost to the network. This approach is typically reactive and provides sub-optimal use of resources (RUs and spectrum) in the network.

While the problems described above involve 5G NR systems, a similar problem exists in LTE. Therefore, although the following embodiments are primarily described as being implemented for use to provide 5G NR service, it is to be understood the techniques described here can be used with other wireless interfaces (for example, fourth generation (4G) Long-Term Evolution (LTE) service) and references to “gNB” can be replaced with the more general term “base station” or “base station entity” and/or a term particular to the alternative wireless interfaces (for example, “enhanced NodeB” or “eNB”). Furthermore, it is also to be understood that 5G NR embodiments can be used in both standalone and non-standalone modes (or other modes developed in the future), and the following description is not intended to be limited to any particular mode. Also, unless explicitly indicated to the contrary, references to “layers” or a “layer” (for example, Layer-1, Layer-2, Layer-3, the Physical Layer, the MAC Layer, etc.) set forth herein refer to layers of the wireless interface (for example, 5G NR or 4G LTE) used for wireless communication between a base station and user equipment).

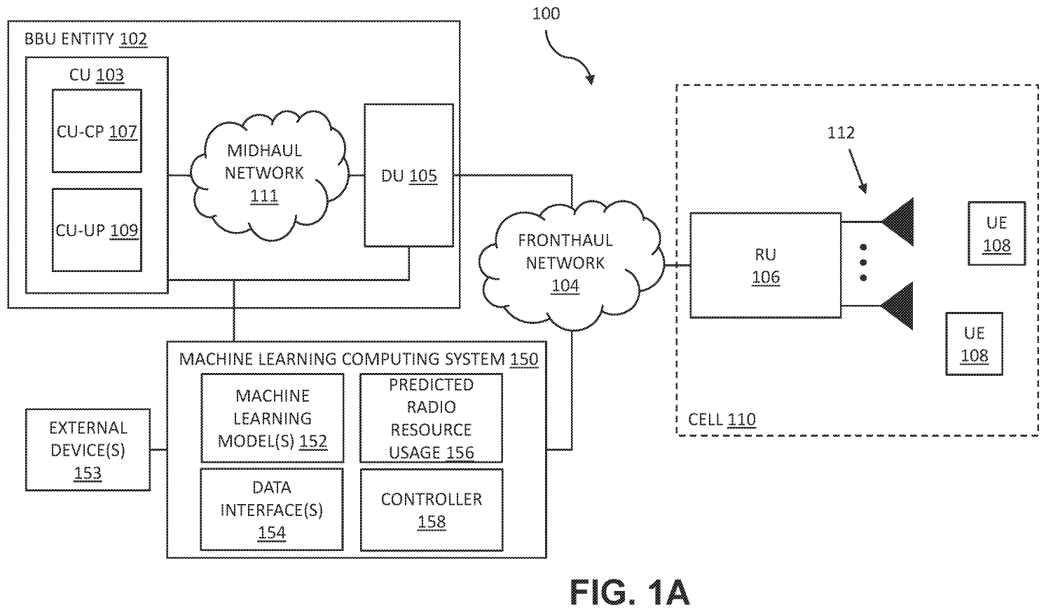

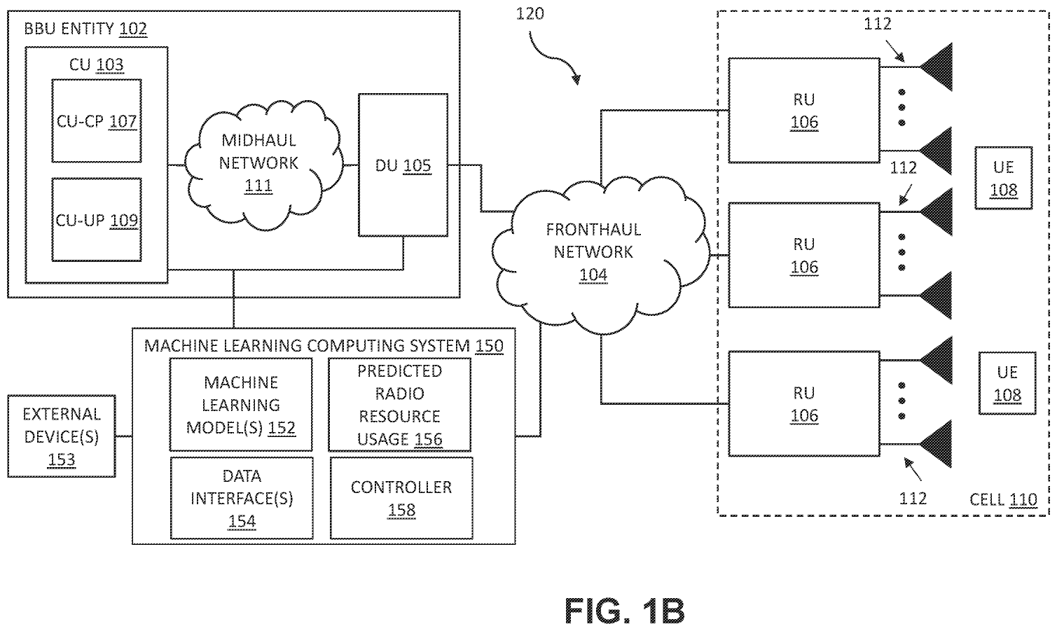

FIG. 1A is a block diagram illustrating an example base station 100 in which the techniques for radio resource usage described herein can be implemented. In the particular example shown in FIG. 1A, the base station 100 includes one or more baseband unit (BBU) entities 102 communicatively coupled to a RU 106 via a fronthaul network 104. The base station 100 provides wireless service to various items of user equipment (UEs) 108 in a cell 110. Each BBU entity 102 can also be referred to simply as a “BBU.”

In the example shown in FIG. 1A, the one or more BBU entities 102 comprise one or more central units (CUs) 103 and one or more distributed units (DUs) 105. Each CU 103 implements Layer-3 and non-time critical Layer-2 functions for the associated base station 100. Each DU 105 is configured to implement the time critical Layer-2 functions and at least some of the Layer-1 (also referred to as the Physical Layer) functions for the associated base station 100. Each CU 103 can be further partitioned into one or more control-plane and user-plane entities 107, 109 that handle the control-plane and user-plane processing of the CU 103, respectively. Each such control-plane CU entity 107 is also referred to as a “CU-CP” 107, and each such user-plane CU entity 109 is also referred to as a “CU-UP” 109.

The RU 106 is configured to implement the control-plane and user-plane Layer-1 functions not implemented by the DU 105 as well as the radio frequency (RF) functions. The RU 106 is typically located remotely from the one or more BBU entities 102. In the example shown in FIG. 1A, the RU 106 is implemented as a physical network function (PNF) and is deployed in or near a physical location where radio coverage is to be provided in the cell 110. In the example shown in FIG. 1A, the RU 106 is communicatively coupled to the DU 105 using a fronthaul network 104. In some examples, the fronthaul network 104 is a switched Ethernet fronthaul network (for example, a switched Ethernet network that supports the Internet Protocol (IP)).

The RU 106 includes or is coupled to a set of antennas 112 via which downlink RF signals are radiated to UEs 108 and via which uplink RF signals transmitted by UEs 108 are received. In some examples, the set of antennas 112 includes two or four antennas. However, it should be understood that the set of antennas 112 can include two or more antennas 112. In one configuration (used, for example, in indoor deployments), the RU 106 is co-located with its respective set of antennas 112 and is remotely located from the one or more BBU entities 102 serving it. In another configuration (used, for example, in outdoor deployments), the antennas 112 for the RU 106 are deployed in a sectorized configuration (for example, mounted at the top of a tower or mast). In such a sectorized configuration, the RU 106 need not be co-located with the respective sets of antennas 112 and, for example, can be located at the base of the tower or mast structure, for example, and, possibly, co-located with its serving one or more BBU entities 102.

While the example shown in FIG. 1A shows a single CU-CP 107, a single CU-UP 109, a single DU 105, and a single RU 106 for the base station 100, it should be understood that this is an example and other numbers of BBU entities, components of the BBU entities, and/or RUs can also be used.

FIG. 1B is a block diagram illustrating an example base station 120 in which the techniques for radio resource usage described herein can be implemented. In the particular example shown in FIG. 1B, the base station 120 includes one or more BBU entities 102 communicatively coupled to multiple RUs 106 via a fronthaul network 104. The base station 120 provides wireless service to various UEs 108 in a cell 110. Each BBU entity 102 can also be referred to simply as a “BBU.”

In the example shown in FIG. 1B, the one or more BBU entities 102 comprise one or more CUs 103 and one or more DUs 105. Each CU 103 implements Layer-3 and non-time critical Layer-2 functions for the associated base station 100. Each DU 105 is configured to implement the time critical Layer-2 functions and at least some of the Layer-1 (also referred to as the Physical Layer) functions for the associated base station 120. Each CU 103 can be further partitioned into one or more control-plane and user-plane entities 107, 109 that handle the control-plane and user-plane processing of the CU 103, respectively. Each such control-plane CU entity 107 is also referred to as a “CU-CP” 107, and each such user-plane CU entity 109 is also referred to as a “CU-UP” 109.

The RUs 106 are configured to implement the control-plane and user-plane Layer-1 functions not implemented by the DU 105 as well as the radio frequency (RF) functions. Each RU 106 is typically located remotely from the one or more BBU entities and located remotely from other RUs 106. In the example shown in FIG. 1B, each RU 106 is implemented as a physical network function (PNF) and is deployed in or near a physical location where radio coverage is to be provided in the cell 110. In the example shown in FIG. 1B, the RUs 106 are communicatively coupled to the DU 105 using a fronthaul network 104. In some examples, the fronthaul network 104 is a switched Ethernet fronthaul network (for example, a switched Ethernet network that supports the Internet Protocol (IP)).

Each of the RUs 106 includes or is coupled to a respective set of antennas 112 via which downlink RF signals are radiated to UEs 108 and via which uplink RF signals transmitted by UEs 108 are received. In some examples, each set of antennas 112 includes two or four antennas. However, it should be understood that each set of antennas 112 can include two or more antennas 112. In one configuration (used, for example, in indoor deployments), each RU 106 is co-located with its respective set of antennas 112 and is remotely located from the one or more BBU entities 102 serving it and the other RUs 106. In another configuration (used, for example, in outdoor deployments), the sets of antennas 112 for the RUs 106 are deployed in a sectorized configuration (for example, mounted at the top of a tower or mast). In such a sectorized configuration, the RUs 106 need not be co-located with the respective sets of antennas 112 and, for example, can be located at the base of the tower or mast structure, for example, and, possibly, co-located with the serving one or more BBU entities 102. Other configurations can be used.

The base stations 100, 120 that include the components shown in FIGS. 1A-1B can be implemented using a scalable cloud environment in which resources used to instantiate each type of entity can be scaled horizontally (that is, by increasing or decreasing the number of physical computers or other physical devices) and vertically (that is, by increasing or decreasing the “power” (for example, by increasing the amount of processing and/or memory resources) of a given physical computer or other physical device). The scalable cloud environment can be implemented in various ways. For example, the scalable cloud environment can be implemented using hardware virtualization, operating system virtualization, and application virtualization (also referred to as containerization) as well as various combinations of two or more of the preceding. The scalable cloud environment can be implemented in other ways. In some examples, the scalable cloud environment is implemented in a distributed manner. That is, the scalable cloud environment is implemented as a distributed scalable cloud environment comprising at least one central cloud, at least one edge cloud, and at least one radio cloud.

In some examples, one or more components of the one or more BBU entities 102 (for example, the CU 103, CU-CP 107, CU-UP 109, and/or DU 105) are implemented as a software virtualized entities that are executed in a scalable cloud environment on a cloud worker node under the control of the cloud native software executing on that cloud worker node. In some such examples, the DU 105 is communicatively coupled to at least one CU-CP 107 and at least one CU-UP 109, which can also be implemented as software virtualized entities. In some other examples, one or more components of the one or more BBU entities 102 (for example, the CU-CP 107, CU-UP 109, and/or DU 105) are implemented as a single virtualized entity executing on a single cloud worker node. In some examples, the at least one CU-CP 107 and the at least one CU-UP 109 can each be implemented as a single virtualized entity executing on the same cloud worker node or as a single virtualized entity executing on a different cloud worker node. However, it is to be understood that different configurations and examples can be implemented in other ways. For example, the CU 103 can be implemented using multiple CU-UPs 109 and using multiple virtualized entities executing on one or more cloud worker nodes. Moreover, it is to be understood that the CU 103 and DU 105 can be implemented in the same cloud (for example, together in a radio cloud or in an edge cloud). In some examples, the DU 105 is configured to be coupled to the CU-CP 107 and CU-UP 109 over a midhaul network 111 (for example, a network that supports the Internet Protocol (IP)). Other configurations and examples can be implemented in other ways.

As discussed above, there is a need to address the ability to improve usage of resources (RUs and spectrum) in networks based on real-time patterns. To help facilitate this for the base station 100, 120, a machine learning computing system 150 is communicatively coupled to one or more components of the base station 100, 120. The machine learning computing system 150 is configured to predict radio resource usage for the base station 100, 120, and the operation of one or more components of the base station 100, 120 is adjusted based on the predicted radio resource usage.

In the examples shown in FIGS. 1A-1B, the machine learning computing system 150 is communicatively coupled to the BBU entity 102 and the RUs 106. In some examples, the machine learning computing system 150 is communicatively coupled to the CU 103, DU 105, and RUs 106. In other examples, the machine learning computing system 150 is communicatively coupled to a subset of the CU 103, DU 105, and RUs 106. In some examples, the machine learning computing system 150 is a general-purpose computing device (for example, a server) equipped with at least one (and optional more than one graphics processing unit (GPU) for faster machine-learning-based processing. In some examples, the machine learning computing system 150 is implemented in more than one physical housing, each with at least one GPU. The machine learning computing system 150 is a host for one or more machine learning models 152 that predict radio resource usage for the base station. In some examples, the machine learning computing system 150 is communicatively coupled to and configured to serve a single base station. In other examples, the machine learning computing system 150 is communicatively coupled to and configured to serve multiple base stations. The number of base stations that the machine learning computing system 150 is communicatively coupled to can be determined based on deployment needs and scale.

In some examples, the machine learning computing system 150 includes one or more interfaces 154 configured to receive time data. The time data can include, for example, the current time of day, day of the week, and/or whether the current day is a holiday. In some examples, the time data is provided by one or more external devices 153 that are separate and distinct from the machine learning computing system 150. For example, the one or more external devices 153 configured to provide time data to the machine learning computing system 150 can be a tracker, sensor, or Internet-of-Things (IOT) device. In other examples, at least a portion of the time data is provided by an internal component of the machine learning computing system 150 (for example, an internal clock).

In some examples, the machine learning computing system 150 also includes one or more interfaces 154 configured to receive traffic data for the base station. The one or more interfaces 154 configured to receive traffic data can be the same interface(s) 154 or different interface(s) 154 compared to the one or more interfaces 154 configured to receive time data. The traffic data can include, for example, a number of UEs in the cell, traffic density in the cell, types of UEs (based on capability) in the cell, and/or identification of primary RUs used to communicate with UEs in the cell. In some examples, the traffic data is provided to the machine learning computing system 150 by one or more components of the base station (for example, the BBU entity and/or the RUs). In other examples, the traffic data is provided to the machine learning computing system 150 by a device that is external to the base station (for example, from a core network communicatively coupled to the base station).

The machine learning computing system 150 includes a machine learning model 152 that is configured to determine predicted radio resource usage 156 of the base station. One or more components of the system are configured to adjust operation of at least one RU 106 based on the predicted radio resource usage 156. In some examples, the one or more components of the system are configured to power on at least one RU 106 that was previously powered off based on the predicted radio resource usage 156 of the base station. In some examples, the one or more components of the system are configured to power off at least one RU 106 based on the predicted radio resource usage 156 of the base station. In some examples, the one or more components are configured to adjust a minimum and/or maximum threshold signal-to-interference ratio or a minimum and/or maximum QSV based on the predicted radio resource usage 156.

In some examples, the machine learning computing system 150 is configured to provide control signals (for example, via controller 158) to the RUs 106 either directly or indirectly via a BBU entity 102. In other examples, the predicted radio resource usage 156 is output to a component of the system (for example, the BBU entity 102), and the component of the system generates and provides control signals to the RUs 106 for changing operation. For example, if the predicted radio resource usage 156 indicates that a particular RU 106 or group of RUs 106 will not be needed in the immediate future, then that particular RU 106 or group of RUs 106 is powered down or otherwise put into a low power mode.

In some examples, the machine learning model 152 is a multinomial regression model, and the machine learning computing system 150 utilizes the time data and the traffic data as independent variables in a predictor function of the machine learning model 152. In such examples, the predicted radio resource usage 156 of the base station is the dependent variable in the predictor function of the machine learning model 152. Each independent variable in the predictor function is associated with a specific weight/coefficient determined via training and the weights/coefficients can be updated during operation of the system.

The time data (including current time of day and day of week) is encoded and used by the machine learning model 152 in a manner that does not apply a higher weight to a particular time of day by default (for example, where 11:00 AM is weighted higher than 10:00 AM by virtue of being associated with a larger number). In some examples, the time of day is divided into segments (for example, 15-minute increments) and the predictor function utilizes a binary variable for indicating that the current time falls within a particular segment. For example, a one can be used to indicate that the current time is within a particular time segment, and a zero can be used to indicate that the current time is not within a particular segment. Similarly, the predictor function can utilize a binary variable for indicating that the current day of the week is a particular day of the week. For example, a one can be used to indicate that the current day of the week is a particular day of the week, and a zero can be used to indicate that the current day of the week is not a particular day of the week.

In examples where the time data also includes information regarding whether the current day is a holiday, this information is also encoded and used by the machine learning model 152 in a manner that does not apply a higher weight to a particular holiday by default. In some examples, the information regarding whether the current day is a holiday can be indicated using a binary variable such that any day that is a holiday will be encoded as a first state (for example, using a one) and any day that is not a holiday will be encoded as the other state (for example, using a zero). In other examples, each specific holiday can be associated with a different independent variable that is binary in a manner similar to the time segments discussed above.

In some examples, the traffic data is encoded and used as a single independent variable in the machine learning model 152. For example, where the traffic data includes a number of UEs in the cell, the independent variable in the predictor function can correspond to the number of UEs in the cell. In other examples, the traffic data can be encoded in different ways. For example, a cell can be divided into sub-areas and the traffic data for each sub-area can be a different independent variable. In some such examples, each independent variable can correspond to the number of UEs in sub-areas of the cell.

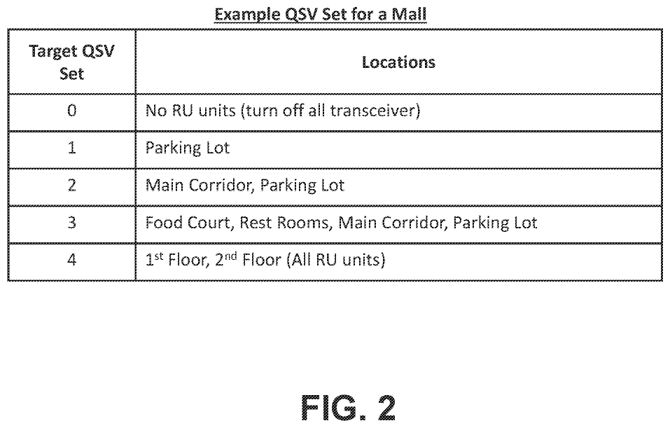

In some examples, the predicted radio resource usage 156 output by the machine learning model 152 includes one or more target quantized signature vector (QSV) sets to be utilized by the base station to meet real-time needs of the network. The target QSV sets correspond to groups of RUs in different areas within a cell that are to be used by the base station for communicating with UEs. For example, in a large venue, such as a shopping mall, there can be different QSVs for RUs in the parking lot, in the food court, on individual floors, or combinations thereof. In some examples, each different combination of groups of RUs to be used by the base station is encoded as a distinct output (dependent variable) of the predictor function of the machine learning model 152. In some examples, the output of the machine learning model 152 is an integer that corresponds to a particular combination of groups of RUs to be used by the base station. A simplified table of target QSV set values and corresponding groups of RUs for a mall is shown in FIG. 2. In some examples, the groups on RUs for each distinct output do not overlap. In the example shown in FIG. 2, the RUs in the different areas (Parking Lot, Main Corridor, Food Court, and Restrooms) don't share a common RU.

While the different target QSV sets can be encoded as a numerical output, each target QSV set represents additional information that is assumed in the machine learning model 152. In some examples, each target QSV set includes a prediction that a particular level of foot traffic will occur in different areas of the cell because the groups of RUs in the target QSV set are required to provide service to UEs predicted to be in the area served by those groups of RUs. Further, in some examples, each target QSV set also includes a prediction that a particular amount or level of resources will be required in the cell because the groups of RUs in the target QSV set are considered in order to provide capacity and frequency reuse needs to communicate with UEs. “Downlink frequency reuse” refers to situations where separate downlink user data intended for different UEs is simultaneously wirelessly transmitted to the UEs using the same physical resource blocks (PRBs) for the same cell. “Uplink frequency reuse” refers to situations where separate uplink user data from different UEs is simultaneously wirelessly transmitted from the UEs using the same physical resource blocks (PRBs) for the same cell. Such reuse UEs are also referred to here as being “in reuse” with each other. Typically, frequency reuse is implemented where the UEs in reuse are sufficiently physically separated from each other so that the co-channel interference resulting from the different wireless transmissions using different RUs is sufficiently low (that is, where there is sufficient RF isolation).

In order to reliably predict the radio resource usage for the base station, the machine learning model 152 is trained in order to determine the weights/coefficients using supervised learning prior to operation. In some examples, synthetic (non-real world) time data and traffic data are generated for the independent variables and synthetic predicted radio resource usage is generated for dependent variables. In other examples, sensors can be distributed throughout the cell to generate measured time data and traffic data that is used for training. In some examples, the weights/coefficients are determined using an iterative procedure or other supervised learning training techniques. In some examples, the objective for training the machine learning model 152 is to maximize non-overlapping target QSV sets while optimizing the number of RUs transmitting for any given day and time.

Once the machine learning model 152 is trained, the machine learning computing system 150 is configured to use the time data and the traffic data as inputs for the machine learning model 152 and determine a predicted radio resource usage 156 for the base station. In some examples, the machine learning computing system 150 is configured to perform additional learning during operation and adapt the weights/coefficients based on real world time data, traffic data, and one or more performance indicators (for example, quality of service, etc.) for the base station.

In some examples, the number of independent variables of the machine learning model 152 can be selected during training based on the desired level of accuracy and computational load demands for the machine learning model 152. In theory, a greater number of independent variables for the time data and the traffic data can provide a more accurate prediction of the radio resource usage of the base station assuming that the machine learning model 152 is sufficiently trained. However, the computational load demands and the time required for training increase when using a higher number of independent variables.

In some examples, the number of possible distinct outputs (for example, target QSV sets) of the machine learning model 152 can be selected during training based on the needs and capabilities of the system. Some factors that can used to determine the number of distinct outputs can include desired level of service for UEs in various traffic scenarios, desired energy use reduction, system capabilities for transport (for example, multicasting), and the like. In general, a greater number of possible distinct outputs of the machine learning model 152 can help reduce the amount of energy used because smaller groups of RUs can be selected for use compared to a lower number of possible distinct outputs. However, the machine learning model 152 will likely take longer to train if there is a large number of possible distinct outputs.

While a single machine learning model 152 may provide sufficient accuracy for most applications, it may be desirable or necessary to increase the accuracy of the predicted radio resource usage 156 of the base station. One potential approach for increasing the accuracy of the predicted radio resource usage 156 of the base station is to use multiple machine learning models 152 that are each specific to a subset of the time data and/or the traffic data. This approach reduces the number of independent variables, which reduces the complexity of the predictor function and can result in reduced computational load and/or increased accuracy of the output.

In some examples, multiple machine learning models 152 directed to specific subsets of the time data are utilized by the machine learning computing system 150. In some such examples, each respective machine learning model 152 is directed to a particular time of day (for example, morning, afternoon, or evening). In other such examples, each respective machine learning model 152 is directed to a particular day of the week (for example, Monday, Tuesday, etc.) or grouped day of the week (for example, weekdays or weekends). In other such examples, each respective machine learning model 152 is directed to a particular holiday status (for example, holiday or non-holiday).

In some examples, multiple machine learning models 152 directed to specific subsets of the traffic data are utilized by the machine learning computing system 150. In some such examples, each respective machine learning model 152 is directed to a specific sub-area of the cell and uses only traffic data for that specific sub-area as an input. In other such examples, each respective machine learning model 152 is directed to a specific operator and uses only traffic data for that specific operator as an input. In some examples where the machine learning models 152 are operator-specific, a particular RU is turned on/off depending on whether it is needed for any operator. For example, if a single operator machine learning model 152 indicates that the RU is needed, then the RU is turned on or kept on. However, if no operator machine learning model 152 indicates that the RU is needed, then the RU is turned off.

While machine learning model(s) used to turn on/off entire RUs may provide sufficient functionality for some applications, it may be desirable or necessary to provide more flexible functionality for some applications. One potential approach for increasing the flexibility is to use multiple machine learning models 152 that are each specific to a particular frequency band or band class, which enables predictions to be made regarding whether particular frequency bands are needed at particular RUS.

In some examples, multiple machine learning models 152 directed to specific frequency bands or band classes are utilized by the machine learning computing system 150. In such examples, each respective machine learning model 152 is directed to a specific frequency band or band class used in the cell. In some such examples, all of the machine learning model 152 use the same time data and traffic data as inputs for the independent variables, but each machine learning model 152 predicts the radio resource usage for a specific frequency band or band class. In other examples, each machine learning model 152 uses traffic data that is specific to the particular frequency band or band class (for example, number of UEs utilizing the particular frequency band or band class) and predicts the radio resource usage for that specific frequency band or band class.

In some examples, multiple machine learning models 152 directed to a combination of the subsets discussed above can be used to increase the accuracy of the predicted radio resource usage 156 and/or enabling different functionality depending on the needs of the system. For example, some of the machine learning models 152 can be operator-specific and directed to a particular frequency band or band class. In such examples, the subset of resources (for example, frequency band(s)) or services (for example, multiple-input-multiple-output (MIMO)) specific to particular operators can be enabled/disabled depending on the outputs of the machine learning models 152.

Completely deactivating RUs 106, frequency bands, or services may not be feasible because the likelihood of an outlier event (for example, where there is an unexpectedly large amounts of UEs in the cell) causing degraded coverage/service for UEs 108 in the cell 110 could be too high. In some examples, the base station 100, 120 is configured to temporarily activate an inactive RU 106, frequency band, or service to determine whether it is needed in the cell 110. In some such examples, one or more components of the base station 100, 120 are configured to provide downlink signals to the temporarily activated RU 106 or downlink signals for the temporarily activated frequency band or service to one or more RUs 106 for transmission to UEs 108 in the cell 110. The base station 100, 120 can measure the traffic levels for uplink signals from the UEs 108 in the cell 110 and determine if the temporarily activated RU 106, frequency band, or service should be fully activated to improve service. In some examples, the base station 100, 120 is configured to periodically determine whether inactive RUs 106, frequency bands, or services are needed in the cell 110.

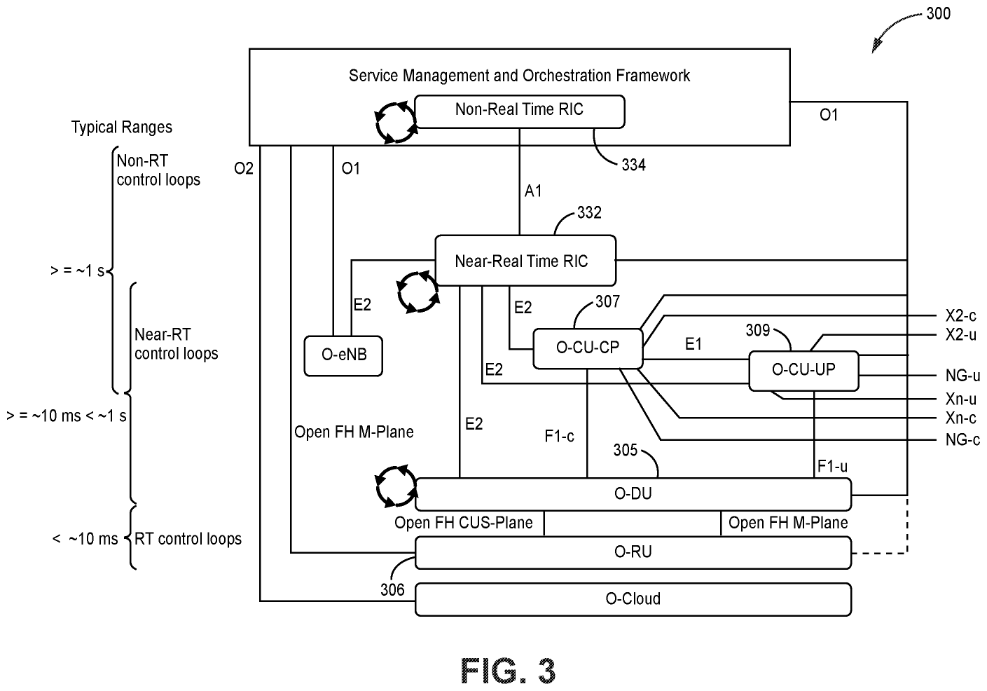

FIG. 3 is a block diagram illustrating an example base station 300 in which the techniques for radio resource usage described herein can be implemented. In the particular example shown in FIG. 3, the base station 300 includes one or more central units (CUs), one or more distributed units (DUs), and one or more radio units (RUs). Each RU is located remotely from each CU and DU serving it.

The base station 300 is implemented in accordance with one or more public standards and specifications. In some examples, the base station 300 is implemented using the logical RAN nodes, functional splits, and fronthaul interfaces defined by the Open Radio Access Network (O-RAN) Alliance. In the example shown in FIG. 3, each CU, DU, and RU is implemented as an O-RAN central unit (O-CU), O-RAN distributed unit (O-DU) 305, and O-RAN radio unit (O-RU) 306, respectively, in accordance with the O-RAN specification.

In the example shown in FIG. 3, the base station 300 includes a single O-CU, which is split between an O-CU-CP 307 that handles control-plane functions and an O-CU-UP 309 that handles user-plane functions. The O-CU comprises a logical node hosting Packet Data Convergence Protocol (PDCP), Radio Resource Control (RRC), Service Data Adaptation Protocol (SDAP), and other control functions. Therefore, each O-CU implements the gNB controller functions such as the transfer of user data, mobility control, radio access network sharing, positioning, session management, etc. The O-CU(s) control the operation of the O-DUs 305 over an interface (including F1-c and F1-u for the control plane and user plane, respectively).

In the example shown in FIG. 3, the single O-CU handles control-plane functions, user-plane functions, some non-real-time functions, and/or PDCP processing. The O-CU-CP 307 may communicate with at least one wireless service provider's Next Generation Cores (NGC) using a 5G NG-c interface and the O-CU-UP 309 may communicate with at least one wireless service provider's NGC using a 5G NG-u interface.

Each O-DU 305 comprises a logical node hosting (performing processing for) Radio Link Control (RLC) and Media Access Control (MAC) layers, as well as optionally the upper or higher portion of the Physical (PHY) layer (where the PHY layer is split between the DU and RU). In other words, the O-DUs 305 implement a subset of the gNB functions, depending on the functional split (between O-CU and O-DU 305). In some configurations, the Layer-3 processing (of the 5G air interface) may be implemented in the O-CU and the Layer-2 processing (of the 5G air interface) may be implemented in the O-DU 305.

The O-RU 306 comprises a logical node hosting the portion of the PHY layer not implemented in the O-DU 305 (that is, the lower portion of the PHY layer) as well as implementing the basic RF and antenna functions. In some examples, the O-RUs 306 may communicate baseband signal data to the O-DUs 305 on the Open Fronthaul CUS-Plane or Open Fronthaul M-plane interface. In some examples, the O-RU 306 may implement at least some of the Layer-1 and/or Layer-2 processing. In some configurations, the O-RUs 306 may have multiple ETHERNET ports and can communicate with multiple switches.

Although the O-CU (including the O-CU-CP 307 and O-CU-UP 309), O-DU 305, and O-RUs 306 are described as separate logical entities, one or more of them can be implemented together using shared physical hardware and/or software. For example, in the example shown in FIG. 3, for each cell, the O-CU (including the O-CU-CP 307 and O-CU-UP 309) and O-DU 305 serving that cell could be physically implemented together using shared hardware and/or software, whereas each O-RU 306 would be physically implemented using separate hardware and/or software. Alternatively, the O-CU(s) (including the O-CU-CP 307 and O-CU-UP 309) may be remotely located from the O-DU(s) 305.

In the example shown in FIG. 3, the base station 300 further includes a non-real time RAN intelligent controller (RIC) 334 and a near-real time RIC 332. The non-real time RIC 334 and the near-real time RIC 332 are separate entities in the O-RAN architecture and serve different purposes. In some examples, the non-real time RIC 334 is implemented as a standalone application in a cloud network. In other examples, the non-real time RIC 334 is integrated with a Device Management System (DMS) or Service Orchestration (SO) tool. In some examples, the near-real time RIC 332 is implemented as a standalone application in a cloud network. In other examples, the near-real time RIC 332 is embedded in the O-CU. The non-real time RIC 334 and/or the near-real time RIC 332 can also be deployed in other ways.

The non-real time RIC 334 is responsible for non-real time flows in the system (typically greater than or equal to 1 second) and configured to execute one or more machine learning models, which are also referred to as “rApps.” The near-real time RIC 332 is responsible for near-real time flows in the system (typically 10 ms to 1 second) and configured to execute one or more machine learning models, which are also referred to as “xApps.”

In some examples, the non-real time RIC 334 shown in FIG. 3 can be configured to operate in a manner similar to the machine learning computing system 150 described above with respect to FIGS. 1A-2. In some such examples, the functionality of the machine learning computing system 150 is implemented as an rApp that is configured to run on the non-real time RIC 334. The non-real time RIC 334 is configured to predict radio resource usage in a manner similar to that described above, and the base station 300 is configured to adjust operation of one or more components of the base station 300 based on the predicted radio resource usage.

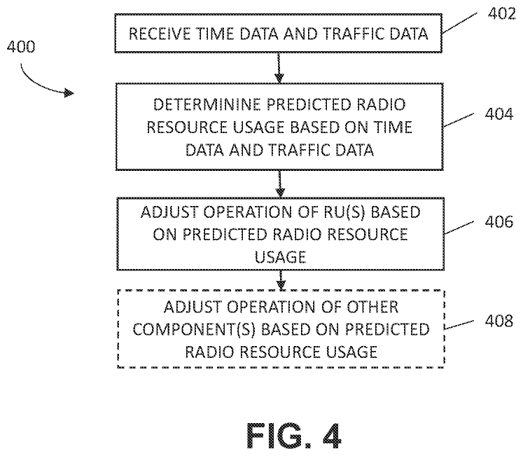

FIG. 4 is a flow diagram of an example method 400 for machine learning based radio resource usage. The common features discussed above with respect to the base stations in FIGS. 1A-3 can include similar characteristics to those discussed with respect to method 400 and vice versa. In some examples, the method 400 is performed by a base station (for example, base station 100, 120, 300).

The method 400 begins with receiving time data and traffic data (block 402). In some examples, the time data includes the current time of day, the current day of the week, and/or whether the current day is a holiday. In some examples, the traffic data includes a number of UEs in the cell, traffic density in the cell, types of UEs (based on capability) in the cell, and/or identification of primary RUs used to communicate with UEs in the cell.

The method 400 includes determining predicted radio resource usage based on the time data and the traffic data (block 404). In some examples, predicting radio resource usage includes predicting the foot traffic in different portions of the cell. In some examples, predicting radio resource usage includes predicting the frequency bands that will be needed to serve UEs in the cell. In some examples, predicting radio resource usage includes predicting reuse requirements for UEs in the cell. The predicted radio resource usage is determined using one or more machine learning models in a manner similar to that discussed above.

The method 400 includes adjusting the operation of one or more radio units (RUs) based on the predicted radio resource usage (block 406). In some examples, adjusting the operation of a RU based on the predicted radio resource usage includes turning the RU completely on or completely off. In some examples, adjusting the operation of a RU based on the predicted radio resource usage includes disabling one or more frequency bands or services utilized at the RU.

In addition to adjusting the operation of one or more RUs, the method 400 optionally includes adjusting the operation of other components of a base station (block 408). For example, when a particular RU is completely turned off or when one or more frequency bands utilized by a particular RU are disabled, the routing of downlink data to that particular RU is disabled completely or disabled for the one or more disabled frequency bands, respectively.

Other examples are implemented in other ways.

The example techniques described herein reduce the energy consumption for operating base stations. The energy savings are typically greater for larger deployments that include more RUs compared to smaller deployments. It should be noted that reduced coverage/service for UEs is possible during outlier events when RUs or frequency bands are deactivated for energy savings. However, improvement of the machine learning computing system over time and the above techniques for testing whether particular RUs and/or frequency bands are needed should help to reduce instances of reduced coverage/service for UEs.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

### EXAMPLE EMBODIMENTS

Example 1 includes a system, comprising: at least one baseband unit (BBU); one or more radio units communicatively coupled to the at least one BBU; one or more antennas communicatively coupled to the one or more radio units, wherein each respective radio unit of the one or more radio units is communicatively coupled to a respective subset of the one or more antennas; wherein the at least one BBU, the one or more radio units, and the one or more antennas are configured to implement a base station for wirelessly communicating with user equipment; and a machine learning computing system configured to: receive time data and traffic data; and determine a predicted radio resource usage of the base station based on the time data and the traffic data; wherein the system is configured to adjust operation of at least one radio unit of the one or more radio units based on the predicted radio resource usage of the base station.

Example 2 includes the system of Example 1, wherein the time data and traffic data includes: time of day; day of week; and a number of user equipment wirelessly communicating with the base station.

Example 3 includes the system of any of Examples 1-2, wherein at least some of the time data and/or the traffic data are provided by one or more devices external to the system.

Example 4 includes the system of any of Examples 1-3, wherein the system is configured to power on at least one radio unit of the one or more radio units based on the predicted radio resource usage of the base station.

Example 5 includes the system of any of Examples 1-4, wherein the system is configured to power off at least one radio unit of the one or more radio units based on the predicted radio resource usage of the base station.

Example 6 includes the system of any of Examples 1-5, wherein the system is configured to activate one or more frequency bands utilized by the one or more radio units based on the predicted radio resource usage of the base station.

Example 7 includes the system of any of Examples 1-6, wherein the system is configured to deactivate one or more frequency bands utilized by the one or more radio units based on the predicted radio resource usage of the base station.

Example 8 includes the system of any of Examples 1-7, wherein the system is further configured to: periodically determine whether a deactivated frequency band is needed; and reactivate the deactivated frequency band in response to a determination that the deactivated frequency band is needed.

Example 9 includes the system of any of Examples 1-8, wherein the system is configured to determine whether or not to utilize a radio unit for downlink frequency reuse or uplink frequency reuse based on the predicted radio resource usage.

Example 10 includes the system of any of Examples 1-9, wherein the machine learning computing system is configured to utilize the time data and the traffic data as inputs to a plurality of machine learning models, wherein each machine learning model of the plurality of machine learning models is directed to a specific sub-area of a service area, a specific frequency band, and/or a specific operator.

Example 11 includes the system of any of Examples 1-10, wherein the one or more radio units includes a plurality of radio units, wherein the one or more antennas includes a plurality of antennas.

Example 12 includes the system of any of Examples 1-11, wherein the BBU includes a central unit communicatively coupled to a distributed unit, wherein the distributed unit is communicatively coupled to the one or more radio units.

Example 13 includes the system of Example 12, wherein the machine learning computing system is implemented in a radio access network intelligent controller.

Example 14 includes a method, comprising: receiving time data and traffic data; determining a predicted radio resource usage of a base station based on the time data and the traffic data, wherein the base station includes at least one baseband unit (BBU), one or more radio units communicatively coupled to the at least one BBU, and one or more antennas communicatively coupled to the one or more radio units, wherein each respective radio unit of the one or more radio units is communicatively coupled to a respective subset of the one or more antennas, wherein the at least one BBU, the one or more radio units, and the one or more antennas are configured to implement a base station for wirelessly communicating with user equipment; and adjusting operation of at least one radio unit of the one or more radio units based on the predicted radio resource usage of the base station.

Example 15 includes the method of Example 14, wherein the time data and traffic data includes: time of day; day of week; and a number of user equipment wirelessly communicating with the base station.

Example 16 includes the method of any of Examples 14-15, wherein receiving time data and traffic data includes: receiving at least some of the time data from one or more devices external to the base station; and/or receiving at least some of the traffic data from one or more devices external to the base station.

Example 17 includes the method of any of Examples 14-16, wherein adjusting operation of at least one radio unit of the one or more radio units based on the predicted radio resource usage of the base station includes: powering on at least one radio unit of the one or more radio units based on the predicted radio resource usage of the base station; and/or powering off at least one radio unit of the one or more radio units based on the predicted radio resource usage of the base station.

Example 18 includes the method of any of Examples 14-17, wherein adjusting operation of at least one radio unit of the one or more radio units based on the predicted radio resource usage of the base station includes: activating one or more frequency bands utilized by the one or more radio units based on the predicted radio resource usage of the base station; and/or deactivating one or more frequency bands utilized by the one or more radio units based on the predicted radio resource usage of the base station.

Example 19 includes the method of any of Examples 14-18, further comprising: periodically determining whether a deactivated frequency band is needed; and reactivating the deactivated frequency band in response to a determination that the deactivated frequency band is needed.

Example 20 includes the method of any of Examples 14-19, further comprising determining whether or not to utilize a radio unit for downlink frequency reuse or uplink frequency reuse based on the predicted radio resource usage.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A system, comprising:
at least one baseband unit (BBU);
one or more radio units communicatively coupled to the at least one BBU;
one or more antennas communicatively coupled to the one or more radio units, wherein each respective radio unit of the one or more radio units is communicatively coupled to a respective subset of the one or more antennas;
wherein the at least one BBU, the one or more radio units, and the one or more antennas are configured to implement a base station for wirelessly communicating with user equipment; and
a machine learning computing system configured to:
receive time data and traffic data; and
determine a predicted radio resource usage of the base station based on the time data and the traffic data;
wherein the system is configured to adjust operation of at least one radio unit of the one or more radio units based on the predicted radio resource usage of the base station.

2. The system of claim 1, wherein the time data and traffic data includes:
time of day;
day of week; and
a number of user equipment wirelessly communicating with the base station.

3. The system of claim 1, wherein at least some of the time data and/or the traffic data are provided by one or more devices external to the system.

4. The system of claim 1, wherein the system is configured to power on at least one radio unit of the one or more radio units based on the predicted radio resource usage of the base station.

5. The system of claim 1, wherein the system is configured to power off at least one radio unit of the one or more radio units based on the predicted radio resource usage of the base station.

6. The system of claim 1, wherein the system is configured to activate one or more frequency bands utilized by the one or more radio units based on the predicted radio resource usage of the base station.

7. The system of claim 1, wherein the system is configured to deactivate one or more frequency bands utilized by the one or more radio units based on the predicted radio resource usage of the base station.

8. The system of claim 1, wherein the system is further configured to:
periodically determine whether a deactivated frequency band is needed; and
reactivate the deactivated frequency band in response to a determination that the deactivated frequency band is needed.

9. The system of claim 1, wherein the system is configured to determine whether or not to utilize a radio unit for downlink frequency reuse or uplink frequency reuse based on the predicted radio resource usage.

10. The system of claim 1, wherein the machine learning computing system is configured to utilize the time data and the traffic data as inputs to a plurality of machine learning models, wherein each machine learning model of the plurality of machine learning models is directed to a specific sub-area of a service area, a specific frequency band, and/or a specific operator.

11. The system of claim 1, wherein the one or more radio units includes a plurality of radio units, wherein the one or more antennas includes a plurality of antennas.

12. The system of claim 1, wherein the BBU includes a central unit communicatively coupled to a distributed unit, wherein the distributed unit is communicatively coupled to the one or more radio units.

13. The system of claim 12, wherein the machine learning computing system is implemented in a radio access network intelligent controller.

14. A method, comprising:
receiving time data and traffic data;
determining a predicted radio resource usage of a base station based on the time data and the traffic data, wherein the base station includes at least one baseband unit (BBU), one or more radio units communicatively coupled to the at least one BBU, and one or more antennas communicatively coupled to the one or more radio units, wherein each respective radio unit of the one or more radio units is communicatively coupled to a respective subset of the one or more antennas, wherein the at least one BBU, the one or more radio units, and the one or more antennas are configured to implement a base station for wirelessly communicating with user equipment; and
adjusting operation of at least one radio unit of the one or more radio units based on the predicted radio resource usage of the base station.

15. The method of claim 14, wherein the time data and traffic data includes:
time of day;
day of week; and
a number of user equipment wirelessly communicating with the base station.

16. The method of claim 14, wherein receiving time data and traffic data includes:
receiving at least some of the time data from one or more devices external to the base station; and/or
receiving at least some of the traffic data from one or more devices external to the base station.

17. The method of claim 14, wherein adjusting operation of at least one radio unit of the one or more radio units based on the predicted radio resource usage of the base station includes:
powering on at least one radio unit of the one or more radio units based on the predicted radio resource usage of the base station; and/or
powering off at least one radio unit of the one or more radio units based on the predicted radio resource usage of the base station.

18. The method of claim 14, wherein adjusting operation of at least one radio unit of the one or more radio units based on the predicted radio resource usage of the base station includes:
activating one or more frequency bands utilized by the one or more radio units based on the predicted radio resource usage of the base station; and/or
deactivating one or more frequency bands utilized by the one or more radio units based on the predicted radio resource usage of the base station.

19. The method of claim 14, further comprising:
periodically determining whether a deactivated frequency band is needed; and
reactivating the deactivated frequency band in response to a determination that the deactivated frequency band is needed.

20. The method of claim 14, further comprising determining whether or not to utilize a radio unit for downlink frequency reuse or uplink frequency reuse based on the predicted radio resource usage.
